(19) United States
(12) Patent Application Publication
(10) Pub. No.: US 2013/0019112 A1
(43) Pub. Date: Jan. 17, 2013

(54) Power control module

(71) Applicant: Chi-Ming Chien, Taipei City (TW)

(72) Inventor: Chi-Ming Chien, Taipei City (TW)

(73) Assignee: SEVENTEAM ELECTRONICS CO., LTD., Taipei City (TW)

(21) Appl. No.: 13/067,974

(22) Filed: Jul. 13, 2011

(51) Int. Cl. G06F 1/26

(52) U.S. Cl. 713/300

(57) ABSTRACT

A power control module installed in the power supply device of a computer for power control is disclosed to include an electric switch member for switching on/off power supply conduction between the power supply device and the motherboard of the computer, and a sensor for sensing the power-on/off current signal of the motherboard of the computer and driving the electric switch member to switch off power supply conduction between the power supply device and the motherboard of the computer when the user switched off the computer after work.

### BACKGROUND OF THE INVENTION

1. Field of the Invention

The present invention relates to power control technology and more particularly, to a power control module for use in a computer, which detects the power-on/off current signal of the motherboard of the computer and automatically switches off power supply conduction between the power supply device and the motherboard of the computer when the user switches off the computer.

2. Description of the Related Art

Following the progress of modern technology, many advanced products are created and used in different fields to help improve the quality of life for people. Nowadays, computer has become an important implement to many people, either in at work, at home, in school, or during an entertainment. Many different advanced power-saving designs of computers, such as notebook, tablet PC, palmtop computer that have light, thin, short and small characteristics are now commercially available and have become the mainstream in the market.

A personal computer generally uses a power cable to obtain the necessary working power supply from a city power supply outlet. In this case, the user must unplug the power cable from the city power supply outlet to completely cut off power supply from the computer. When using the computer again, the user must connect the power cable to the city power supply outlet again. It is inconvenient to frequently plug and unplug the electric plug of the power cable. Further, the user may forget to unplug the power cable from the city power supply outlet after switched off the computer. In this case, the user may encounter the following problems:
1. Each time the user switches off the power switch of the computer, the user must unplug the power cable of the computer from the city power supply outlet to avoid idle power loss. If the user forgets to unplug the power cable from the city power supply outlet after work, the computer keeps consuming a certain amount of power supply, causing idle power loss and discharge of carbon dioxide.
2. It is inconvenient to plug the power cable of the computer before using the computer or to unplug the power cable of the computer after a use of the computer.

Therefore, it is desirable to provide a power control module for computer that automatically cuts off power supply from the motherboard of the computer when the user switches off the power switch of the computer.

### SUMMARY OF THE INVENTION

The present invention has been accomplished under the circumstances in view. It is one object of the present invention to provide a power control module for use in a computer, which automatically cuts off power supply conduction between the power supply device and the motherboard when the user switches off the computer after work, reducing idle power loss and carbon dioxide discharge and doing help on stopping global warming.

To achieve this and other objects of the present invention, a power control module is installed in a power supply device of a computer for controlling power supply conduction between said power supply device and the motherboard of said computer, comprising a power supply mainboard, an electric switch member installed in the power supply mainboard and electrically coupled between the power supply device and the motherboard of the computer and adapted for switching on/off power supply conduction between the power supply device and the motherboard of the computer, and a sensor installed in the power supply mainboard and electrically coupled with the electric switch member and the motherboard of the computer and adapted for sensing the power-on/off current signal of the motherboard and controlling the electric switch member to cut off power supply conduction between the power supply device and the motherboard of the computer when the computer is switched off by a user.

The power control module further comprises a manual button extending out of the power supply device for operation by a person to switch on/off the electric switch member manually.

The power control module further comprises a built-in counter that starts counting a predetermined length of time (for example, 60 seconds, 90 seconds) after the electric switch member switched on the circuit. The user must switch on the power switch of the computer within the set length of time. At this time, the sensor detects the current intensity of the current signal of the computer, and will drive the electric switch member to switch off the circuit if the computer is not started up within the set length of time.

### BRIEF DESCRIPTION OF THE DRAWINGS

FIG. 1 is a circuit block diagram of the present invention.

FIG. 2 is a schematic drawing illustrating the power control module installed in the power supply device in a computer in accordance with the present invention.

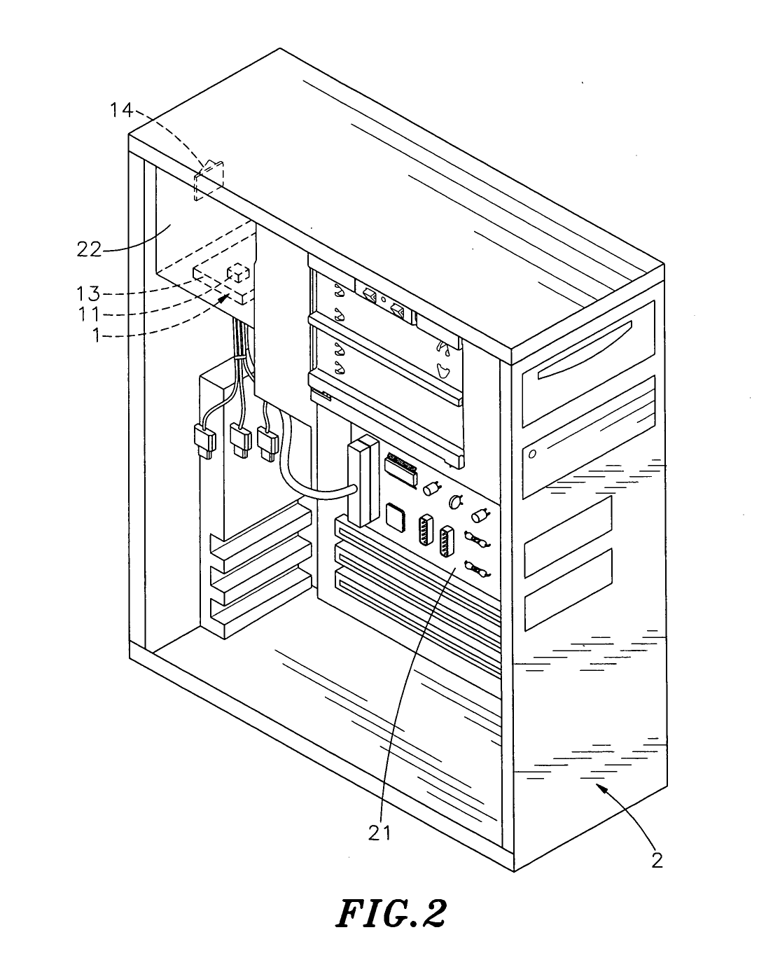

FIG. 3 is a circuit diagram of the present invention.

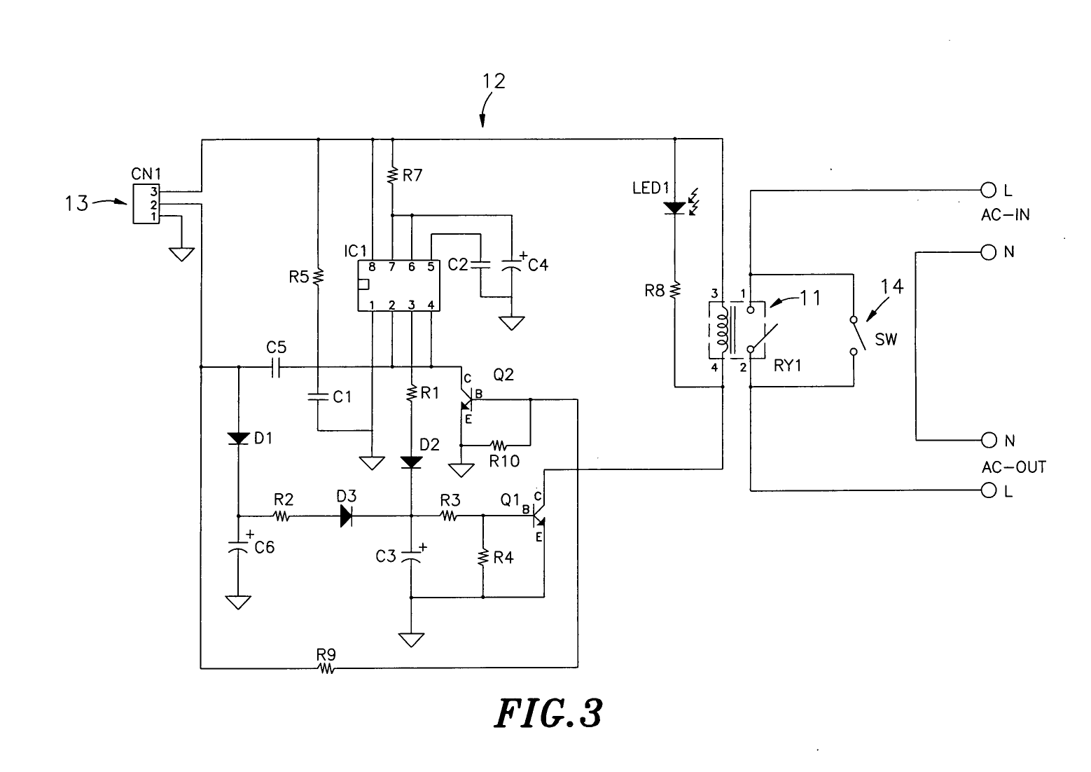

### DETAILED DESCRIPTION OF THE PREFERRED EMBODIMENT

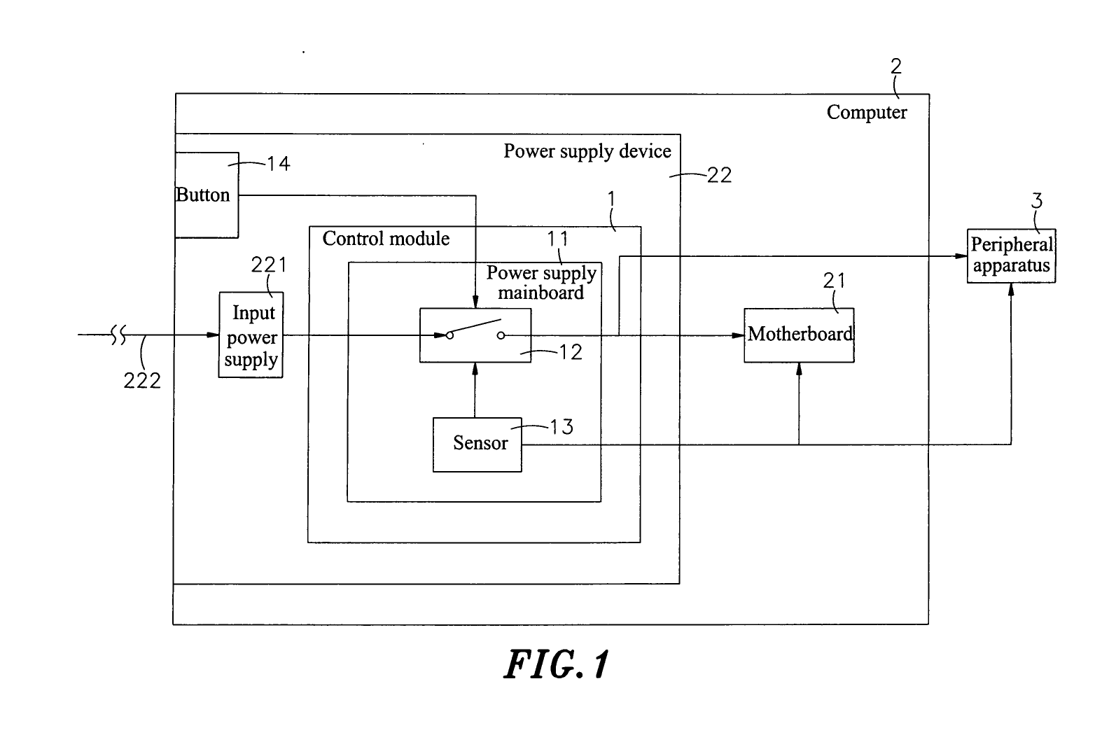

Referring to FIGS. 1˜3, a power control module 1 in accordance with the present invention is shown installed in a power supply device 22 of a computer 2.

The power control module 1 comprises a power supply mainboard 11, an electric switch member 12, a sensor 13, and a manual button 14. The electric switch member 12, the sensor 13, and the manual button 14 are installed in the power supply mainboard 11. The electric switch member 12 is electrically coupled between the motherboard 21 of the computer 2 and the input power supply 221 of the power supply device 22 (which is obtained from an external AC power source by a power cable 222). The sensor 13 detects the on/off current signal of the motherboard 21 of the computer 2, and controls the electric switch member 12 to conduct electricity from the power supply device 22 to the motherboard 21 of the computer 2 or to cut off electricity from the motherboard 21 of the computer 2 subject to its detection result. The manual button 14 extends to the outside of the power supply device 22, and manually operable to switch on/off the electric switch member 12 for letting electricity be conducted to, or cut off from, the motherboard 21 of the computer 2.

The input power supply 221 of the power supply device 22 is an AC power supply obtained a city AC power outlet so that the power supply device 22 can provide the necessary working power supply to the motherboard 21 of the computer 2. When the computer 2 is powered off, the motherboard 21 does no work. At this time, the sensor 13 detects an power-off current signal and drives the electric switch member 12 to switch off the circuit, cutting off power supply from the computer 2 and the related peripheral apparatuses 3 (such as: scanner, keyboard, mouse, network telephone and/or web camera) that are electrically coupled to the computer 2.

When the user is going to re-boot the computer 2, the user can press the manual button 14 to switch on the electric switch member 12 for letting electricity be conducted to the motherboard 21 of the computer 2. At this time, the built-in counter (not shown) in the power control module 1 starts counting a predetermined length of time (for example, 60 seconds, 90 seconds). The user must switch on the power switch of the computer 2 within the set length of time. At this time, the sensor 13 detects the current intensity of the current signal of the computer 2 (or the power signal of the related peripheral apparatuses 3), and will drive the electric switch member 12 to switch off the circuit if the computer 2 is not started up within the set length of time.

Further, when the user presses the manual button 14 to switch on the electric switch member 12 manually and the power switch of the computer 2 is switched on within the set length of time after the electric switch member 12 is switched on, power supply is kept conducting from the power supply device 22 to the computer 2 and the connected peripheral apparatus 3 via the electric switch member 12. If the user turns off the computer 2 at this time, the sensor 13 will detect the power-off current signal of the motherboard 21 and drive the electric switch member 12 to switch off the circuit, cutting off power supply from the computer 2 and the related peripheral apparatuses 3.

The aforesaid electric switch member 12 can be an electromagnetic switch or relay that is adapted to conduct an electric current to excite a coil for controlling circuit on/off status.

The main technical feature of the present invention is the use of the sensor 13 of the power control module 1 to detect the current signal of the motherboard 21 of the computer 2, enabling the electric switch member 12 to be controlled by the sensor 13 to switch off electric conduction between the power supply device 2 and the computer 2 and the related peripheral apparatus 3 automatically when the computer 2 is powered off, and therefore power supply is cut off from the computer 2 and the related peripheral apparatuses 3 automatically when the user switches off the computer 2.

In conclusion, the invention provides an electric outlet power control device, which has the advantages and features as follows:
1. The electric switch member 12 of the power control module 1 can automatically switch on/off the circuit between the input power supply 221 of the power supply device 22 and the computer 2. Further, the sensor 13 detects the power-on/off current signal of the computer 2, and drives the electric switch member 12 to cut off power supply from the motherboard 21 of the computer 2 when the computer 2 is switched off by the user, and therefore the computer 2 and the related peripheral apparatuses 3 are synchronously turned off when the user switches off the computer 2, reducing idle power loss and carbon dioxide discharge and doing help on stopping global warming.
2. Subject to the functioning of the sensor 13 to detect the power-on/off current signal of the motherboard 21 of the computer 2 and to drive the electric switch member 12 to switch off the circuit when the computer 2 is off, the user needs not to unplug the power cable when turned off the computer 2 after working.
3. The manual button 14 of the power control module 1 is manually operable by the user to switch on the electric switch member 12, enabling electricity to be transmitted from the power supply device 22 to the motherboard 21 of the computer 2 and the related peripheral apparatus 3. Further, subject to the functioning of the built-in counter to count a predetermined length of time, the sensor 13 will detect the power-off current signal of the computer 2 and drives the electric switch member 12 to cut off power supply from the computer 2 and the related peripheral apparatuses 3 if the computer 2 is not started up within the set length of time.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A power control module installed in a power supply device of a motherboard-based computer for controlling power supply conduction between said power supply device and the motherboard of said computer, the power control module comprising:
a power supply mainboard;
an electric switch member installed in said power supply mainboard and electrically coupled between said power supply device and said motherboard of said computer and adapted for switching on/off power supply conduction between said power supply device and said motherboard of said computer; and
a sensor installed in said power supply mainboard and electrically coupled with said electric switch member and said motherboard of said computer and adapted for sensing the power-on/off current signal of said motherboard and controlling said electric switch member to cut off power supply conduction between said power supply device and said motherboard of said computer when said computer is switched off by a user.

2. The power control module as claimed in claim 1, further comprising a manual button extending out of said power supply device for operation by a person to switch on/off said electric switch member manually.

3. The power control module as claimed in claim 1, wherein said electric switch member of said power control module is an electromagnetic switch.

4. The power control module as claimed in claim 1, wherein said electric switch member of said power control module is a relay.
